(19) United States
(12) Patent Application Publication
(10) Pub. No.: US 2004/0112702 A1
(43) Pub. Date: Jun. 17, 2004

(54) Transmission torque-transmitting mechanism having a ball ramp electric motor apply mechanism

(76) Inventor: Paul D. Stevenson, Ann Arbor, MI (US)

Correspondence Address: LESLIE C. HODGES, General Motors Corporation, Legal Staff, Mail Code 482-C23-B21, P.O. Box 300, Detroit, MI, 48265-3000, US

(21) Appl. No.: 10/319,957

(22) Filed: Dec. 16, 2002

(51) Int. Cl. F16D 3/34

(52) U.S. Cl. 192/45

(57) ABSTRACT

A torque-transmitting mechanism has a stationary housing in which is rotatably supported a wheel which has one or more axially facing ramps formed thereon. An apply plate is slidably disposed in the stationary housing and has one or more axially facing ramps disposed thereon which are axially juxtaposed to the ramps on the wheel. A plurality of spherical members are positioned between the ramps such that rotation of the wheel results in axial movement of the apply plate. The apply plate is axially moved into contact with one or more friction plates to enforce frictional engagement between two portions of a torque-transmitting mechanism disposed within a transmission.

### TECHNICAL FIELD

This invention relates to torque-transmitting mechanisms and, more particularly, to torque-transmitting mechanisms for planetary transmissions wherein at least one member of the torque-transmitting mechanism is housed in a stationary component and is rotatable relative to the stationary component to enforce axial movement of a torque-transmitting apply mechanism.

### BACKGROUND OF THE INVENTION

Multi-speed planetary transmissions have at least one torque-transmitting mechanism and generally more than one. The torque-transmitting mechanisms are either of the stationary type, commonly termed brakes or reaction clutches, or of the rotating type, commonly termed clutches.

A torque-transmitting mechanism includes an apply member which is axially movable relative to a plurality of friction plates to cause frictional engagement between the friction plates thereby providing a drive connection between the alternately spaced plates. The drive may be either stationary, such as a brake, or rotating, such as a clutch.

The apply member is generally slidingly disposed in a housing, which may be either rotating or stationary depending upon the torque-transmitting type utilized. The torque-transmitting mechanisms are most generally engaged by hydraulic forces which act on the apply member to cause the frictional engagement between the interdigitated friction plates. The friction plates transmit torque from one transmission component to another.

In the case of rotating type torque-transmitting mechanisms, the torque is transmitted between two rotating components, while in a stationary type torque-transmitting mechanism, the torque is transmitted from a transmission member to a stationary housing. The hydraulic apply system for the torque-transmitting mechanisms requires the direction of communication of the high pressure fluid from a control pump through the piston chambers for each of the torque-transmitting mechanisms. This requires that the hydraulic fluid be transmitted through the housing assembly and rotating shaft so that all of the torque-transmitting mechanisms can be controlled.

### SUMMARY OF THE INVENTION

It is an object of the present invention to provide an improved torque-transmitting mechanism for a planetary type power transmission.

In one aspect of the present invention, two torque-transmitting members are interconnected by a plurality of spherical members, which permit relative rotation therebetween.

In another aspect of the present invention, at least one of the torque-transmitting members is housed in a stationary component in a transmission.

In yet another aspect of the present invention, the one torque-transmitting member housed in the stationary component is driven rotatably by a worm gear and worm assembly.

In still another aspect of the present invention, the torque-transmitting members each have formed thereon a ramp, which is in contact with the spheres whereby rotation of the one torque-transmitting member results in axial movement of the other torque-transmitting member.

In a further aspect of the present invention, the axially driven torque-transmitting member enforces frictional engagement between a plurality of interdigitated friction plates or discs which result in a transfer of torque from the transmission element to either a stationary component or another rotating component.

In a yet further aspect of the present invention, the ramps formed on the two torque-transmitting members may provide either a single ramp for the circumference of the torque-transmitting member or a plurality of ramps for the circumference of the torque-transmitting members.

### DESCRIPTION OF THE DRAWINGS

FIG. 1 is a cross-sectional elevational view of a portion of a transmission describing the torque-transmitting mechanism incorporating the present invention.

FIG. 2 is a view similar to FIG. 1 describing another embodiment of the present invention.

FIG. 3 is an unwrapped view showing a portion of the circumference of the torque-transmitting mechanisms shown in FIGS. 1 and 2.

FIG. 4 is a view similar to FIGS. 1 and 2 describing another embodiment of the present invention.

FIG. 5 is an unwrapped view of the circumference of the embodiment shown in FIG. 4 providing a single ramp between elements of the torque-transmitting mechanism.

### DESCRIPTION OF THE EXEMPLARY EMBODIMENTS

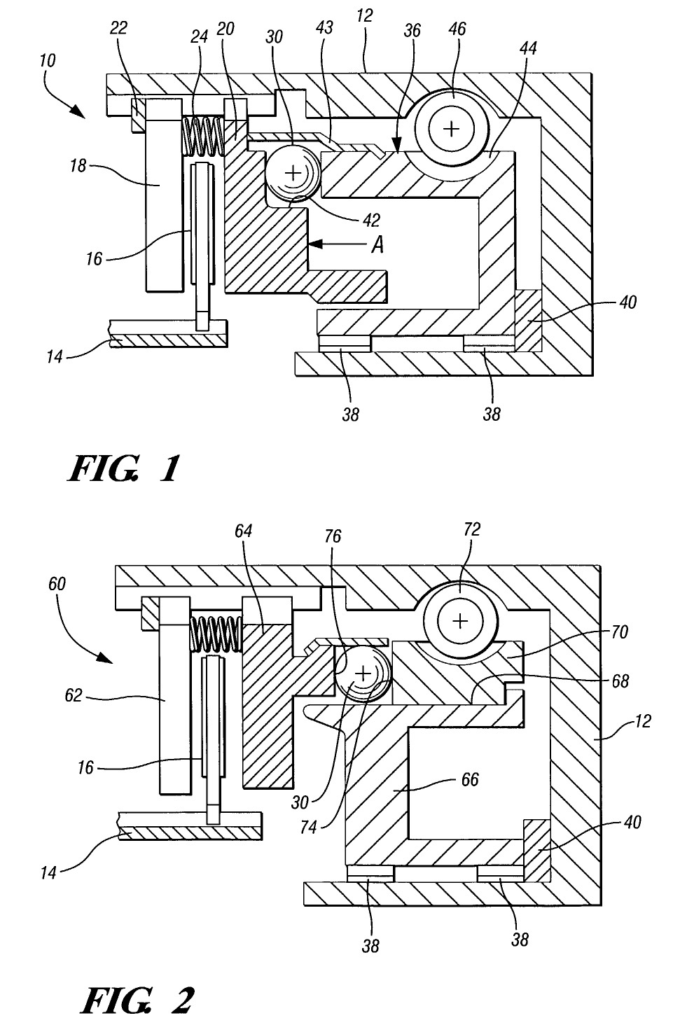

A torque-transmitting mechanism 10 shown in FIG. 1 is a portion of a power transmission. The elements of the transmission are not shown, however, they are conventional devices well known to those skilled in the art. The torque-transmitting mechanism 10 includes a housing portion 12, which is held stationary within the transmission, and a rotatable member 14, which is operatively connected with elements of the transmission such as gears.

A friction disc 16 is splined to the member 14. The friction disc 16 is disposed between a backing plate 18 and an apply plate 20, both of which are splined to the housing 12. The backing plate 18 is limited in leftward movement relative to the housing 12 by a conventional locking or locating ring 22. While the embodiment of FIG. 1 shows a single friction plate 16, it is well known to use a plurality of such plates, which are interdigitated with steel plates or other friction plates splined to the housing 12.

A spring member 24 disposed between the baking plate 18 and the apply plate 20 enforces separation of the friction members 16, 18, and 20 when disengagement of the torque-transmitting mechanism 10 is desired. The apply plate 20 has a plurality of ramps 26 and 28, as seen in FIG. 3. A plurality of spheres or balls 30 are disposed between the ramps 26 and 28 formed on the apply plate 20 and ramps 32 and 34 formed on a wheel 36.

The wheel 36 is rotatably supported on bushings 38 in the housing 12. The wheel 36 is rotatable within the housing 12 and is separated therefrom by a thrust or needle bearing 40. The wheel 36 includes a worm gear 44 formed on the outer periphery thereof, which meshingly engages a worm 46. The worm 46 is driven by a conventional electric motor, not shown. When the worm 46 is driven so as to enforce rotation of the wheel 36, the ramps 32 and 34 will be moved relative to the ramps 26 and 28, which will result in axial movement of the apply plate 20 in the direction of Arrow A. Note that the apply plate 20 is splined to the housing 12 and cannot therefore rotate relative to the housing 12.

The axial movement of the apply plate 20 can enforce frictional engagement between the apply plate 20, the friction plate 16, and the backing plate 18 thereby effectively connecting the housing 12 with the transmission member 14. When the transmission member is connected with a gear within the transmission, that gear member will be held stationary by the housing 12 thereby effectively providing a brake or reaction member within the transmission.

The apply plate 20 has an inner shell or circumference 42 which locates the radially innermost movement allowed to the balls 30 and the wheel 36 has formed thereon a cover or shield 43, which limits the radially outward movement of the balls 30. Thus, the balls 30 are caught within the ramps 26, 28, 32, and 34. To maintain the balls essentially centered within their respective ramp areas, a pair of springs 48 and 50 are disposed between the ramps 28 and 34 and a pair of springs 52 and 54 are disposed between the ramps 26 and 32.

The springs prevent the balls 30 from bottoming out against a shelf 56 formed on the apply plate 20 and a shelf 58 formed on the wheel 36. When it is desired to release the torque-transmitting mechanism 10, the wheel 36 is rotated in the opposite direction by the worm 46 and worm gear 44 to thereby return the apply plate 20 to its original unapplied position such that the spring 24 will enforce separation of the apply plate 20, the friction plate 16, and the backing plate 18. Of course, if a plurality of friction plates and interdigitated steel plates are employed, all of the plates will be separated by a disengagement of the torque-transmitting mechanism which occurs when the apply plate 20 is returned to the unengaged position by the separator springs 24.

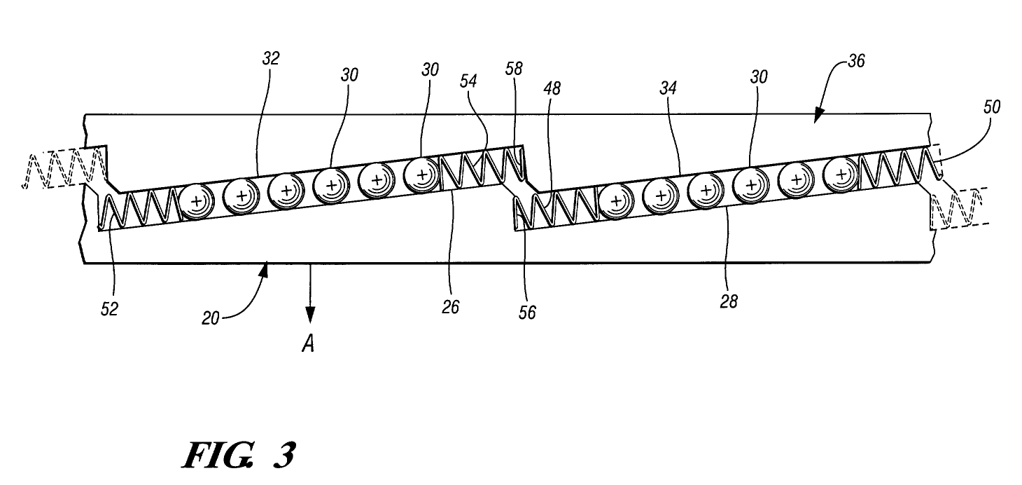

An alternative embodiment is shown in a torque-transmitting mechanism 60 shown in FIG. 2. The torque-transmitting mechanism 60 also has a stationary housing 12 in which is splined a backing plate 62 and an apply plate 64. The backing plate 62 and apply plate 64 sandwich the friction disc 16, which is connected with the transmission member 14. The torque-transmitting mechanism 60 also includes a wheel 66, which is rotatably supported in the housing 12 and bushings 38 and by a thrust bearing 40.

The wheel 66 has an outer circumference or periphery 68, on which a worm gear 70 is secured. The worm gear 70 is disposed in mesh with a worm 72, which is driven by a conventional electric motor, not shown. A plurality of ball members 30 are disposed between the worm gear 70 and the apply plate 64. The ball members 30 are engaged or contacted by ramps 74 and 76 formed on the worm gear 70 and apply plate 64, respectively. The ramps formed on the apply plate 64 and worm gear 70 are similar to the ramps 26, 28, 32, and 34, which are shown in FIG. 3. Thus, at least two ramp structures are formed between the wheel 60 and the apply plate 64 to enforce or to translate the rotational force of the wheel 66 and to axial force in the apply plate 64.

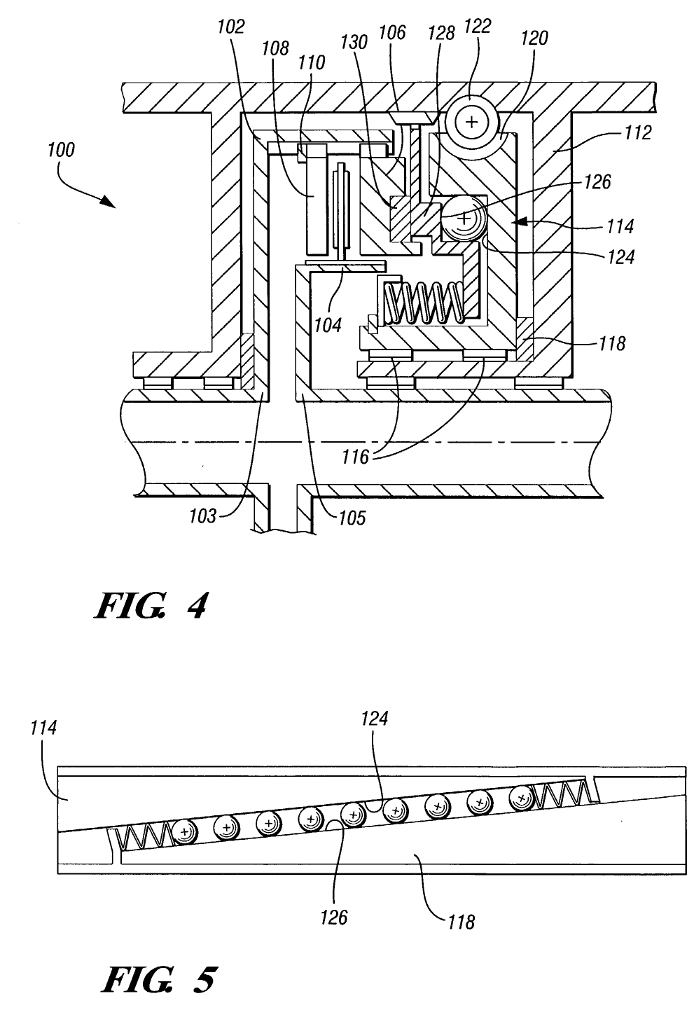

An alternative torque-transmitting mechanism 100 is shown in FIG. 4. The torque-transmitting mechanism 100 has two rotating components 102 and 104, which are connected to at least two different components within the transmission. The rotating component 102 is connected with a shaft 103 and the rotating component 104 is connected with a sleeve shaft 105.

The rotating component 102 has splined thereto an apply plate 106 and a backing plate 108. The backing plate 108 is limited in leftward movement on the component 102 by a conventional by a conventional locking or locating ring 110.

The torque-transmitting mechanism 100 includes a housing 112, which is a component of the transmission housing and is therefore stationary. A wheel 114 is rotatably supported within the housing 112 on bushings 116 and by a thrust or needle bearing 118. These are conventional support devices similar to those described above for FIGS. 1 and 2. The wheel 114 has a worm gear 120 formed thereon, which is disposed in meshing relationship with a worm 122. As with the embodiments shown in FIGS. 1 and 2, the worm 122 is driven by a conventional electric motor.

A ramp 124 is formed on the wheel 114 and another ramp 126 is formed on an intermediate apply plate 128. The intermediate apply plate 128 is disposed adjacent the apply plate 106 and separated therefrom by a needle thrust bearing 130. The plate 128 is splined to the stationary housing 112 such that relative rotation therebetween is not permitted while relative axial movement therebetween is permitted.

As seen in FIG. 5, a single ramp 124 is formed on the wheel 114 and a single ramp 126 is formed on the plate 128. While this arrangement of single ramps is much easier to manufacturer than the double ramp, the double ramp provides a better force balance between the apply mechanisms of the torque-transmitting member and is therefore a slightly more preferred structure. However, a single ramp assembly will work quite well in the devices.

The ramps 126 and 124 are generally formed with an angle of approximately five degrees, which will convert very little input torque from the electric motor into a large amount of thrust. The rolling balls provide a minimum of friction and will operate substantially with less friction than caged rollers while distributing the thrust forces much more evenly.

With the embodiment shown in FIG. 4, the members 102 and 104 are permitted to rotate relative to the housing 112 while the apply plate 128 and is fixed rotatably to the housing 112 and permitted to move axially relative to the housing 112 thereby enforcing axial frictional engagement between the elements 106, 116, and 108. As with the embodiments shown in FIGS. 1 and 2, it is well known within the art that the number friction elements employed is directly related to the maximum torque transmission expectancy from the torque-transmitting mechanism 100.

The ramps 32, 34, and 124 can be considered input ramps or ramps on the input side of the torque-transmitting mechanism, and the ramps 26, 28, and 126 can be considered output ramps or ramps connected to the output portion of the torque-transmitting mechanism. The spline connection between the plates 18, 20, 108, and 106 can be considered one portion of the torque-transmitting mechanism and the members 14 and 104 can be considered other or second portions of the torque-transmitting mechanism. Thus, the engagement of each of the torque-transmitting mechanisms 10, 60, and 100 transmits torque from between the two portions. In the torque-transmitting mechanisms 10 and 60, the torque is transmitted to a stationary portion or housing while in the torque-transmitting mechanism 100 the torque is transmitted between two rotating members. In other words, the torque-transmitting mechanism 100 is a clutch and the torque-transmitting mechanisms 10 and 60 are brakes.

Obviously, the structure shown in FIGS. 1, 2, and 4 can be easily modified those skilled in the art to provide either a stationary type torque-transmitting mechanism or a rotating type torque-transmitting mechanism.

1. A torque-transmitting mechanism comprising:
a stationary housing;
a rotatable member supported in said stationary housing;
an axially movable member slidably disposed in said housing;
a first ramp means formed on said rotatable member;
a second ramp means formed on said axially movable member in axial juxtaposition to said first ramp means;
a plurality of spherical members disposed between and contacting said first and second ramp means; and
means for rotating said rotatable member to enforce relative movement of said ramp means to enforce axial movement of said axially movable member to enforce frictional engagement of a plurality of friction members, said friction members being engaged to transmit torque between first and second portions of said torque-transmitting mechanism.

2. The torque-transmitting mechanism defined in claim 1 further comprising:
one of said first and second portions of said torque transmitting mechanism being continuously connected with said stationary housing.

3. The torque-transmitting mechanism defined in claim 1 further comprising:
both of said first and second portions of said torque transmitting mechanism being rotatable relative to said axially movable member, and means for supporting relative rotation between one of said first and second portions of said torque transmitting mechanism and said axially movable member.
